(19) United States
(12) Patent Application Publication
(10) Pub. No.: US 2024/0230152 A9
(43) Pub. Date: Jul. 11, 2024

(54) HEAT EXCHANGER MODULE, METHOD FOR PROVIDING THE SAME AND MOTOR VEHICLE SYSTEM HAVING AT LEAST ONE HEAT EXCHANGER MODULE

(71) Applicant: MAHLE INTERNATIONAL GMBH, Stuttgart (DE)

(72) Inventors: Ann-Kathrin HAAG, Esslingen (DE); Hicham ROUHANA, Korntal-Münchingen (DE)

(21) Appl. No.: 18/380,790

(22) Filed: Oct. 17, 2023

(30) Foreign Application Priority Data
Oct. 19, 2022 (DE) 102022211077.3

(51) Int. Cl. F24F 13/30; B60H 1/00

(52) U.S. Cl. CPC F24F 13/30; B60H 1/00521

(57) ABSTRACT

The present invention relates to a heat exchanger module for an air-conditioning system or a heat pump system, which comprises a heat exchanger for cooling refrigerant, which is penetrated by a refrigerant channel for refrigerant, and a collector for drying and storing refrigerant, which is penetrated by a storage channel for refrigerant. It is substantial that the heat exchanger module, furthermore, comprises a coupling device equipped for the mechanical and fluidic connection of heat exchanger and collector, by way of which in the assembled state of the heat exchanger module, the heat exchanger is mechanically fixed to the collector and the refrigerant channel fluidically connected to the storage channel. Furthermore, the invention relates to a method for providing such a heat exchanger module and to a motor vehicle system having at least one such heat exchanger module.

### CROSS-REFERENCE TO RELATED APPLICATIONS

This application claims priority from German Patent Application No. DE 10 2022 211 077.3 filed Oct. 19, 2022, the entirety of which is hereby fully incorporated by reference herein.

The invention relates to a heat exchanger module according to the preamble of claim 1. In particular, the invention relates to a method for providing such a heat exchanger module and further in particular to a motor vehicle system having at least one such heat exchanger module.

Heat exchanger modules of the type mentioned at the outset are known for example from DE 10 2019 210 022 A1. They are at least composed of a heat exchanger for cooling refrigerant and of a collector for drying and storing refrigerant wherein the latter is arranged on a mounting surface of the heat exchanger and fluidically and mechanically connected to the same. Because of installation space dimensions specified by the customer it is required here to spatially separate the collector and the heat exchanger from one another, as a result of which at least one additional fluidic connection between the same has to be established in order to maintain the functionality of the heat exchanger module. However, such additional fluidic connections are relatively cost-intensive and large structures, which is undesirable.

The object of the invention therefore consists in providing an improved or at least another embodiment for a heat exchanger module, in particular a simple fluidic connection is to be stated. Further, in particular, a method is to be provided by way of which such a heat exchanger module can be realised. Finally, a motor vehicle system having at least one such heat exchanger module is to be stated as well.

In the present invention, this object is solved in particular through the subjects of the independent claims. Advantageous embodiments are subject of the dependent claims and of the description.

The basic idea of the invention consists in mechanically and/or fluidically interconnecting the heat exchanger and the collector of a heat exchanger module by way of a coupling device.

The exchanger module according to the invention, which can be employed in a motor vehicle system, in particular an air-conditioning system or a heat pump system, comprises for this purpose a heat exchanger penetrated by a refrigerant channel for refrigerant for cooling refrigerant and a collector for drying and storing refrigerant, which is penetrated by a storage channel for refrigerant. It is substantial that a heat exchanger module comprises a coupling device equipped for the mechanical and/or fluidic connection of heat exchanger and collector, by way of which in the assembled state of the heat exchanger module, the heat exchanger is mechanically fixed to the collector and/or the refrigerant channel is fluidically connected to the storage channel. Practically, the coupling device is adapted or adaptable to a size of the heat exchanger, in particular a height of the heat exchanger and for example arranged sandwich-like between the heat exchanger and the collector. Because of this, the collector and the heat exchanger can be relatively flexibly and cost-effectively connected to one another so that in particular a refrigerant circuit can be realised, in which refrigerant can flow from the refrigerant channel of the heat exchanger to the storage channel of the collector and then from the storage channel of the collector back again to the refrigerant channel of the heat exchanger.

By the said sandwich-like arrangement of the coupling device the invention practically means an arrangement in which the coupling device or at least one of its components is clamped in between the heat exchanger and the collector. The coupling device or at least one of its components can be supported on the heat exchanger and/or the collector in a contacting manner.

Practically it is provided that the coupling device is in multiple parts. In particular, the coupling device can have a connecting plate comprising at least two openings and a multi-channel device arranged thereon, wherein the latter comprises a first channel fluidically connected to a first opening of the at least two openings and a second channel fluidically connected to a second opening of the at least two openings. In this connection it can be provided that the collector comprises or forms a connecting flange which comprises a mounting surface equipped for mounting the connecting plate and a pair of channel grooves for conducting refrigerant, which open out on the mounting surface and are fluidically connected to the storage channel. Practically, the connecting plate can be arranged on the mounting surface with a large plate surface located opposite with respect to the multi-channel device in a directly contacting manner or subject to interposing a sealing means and fixed to the connecting flange, so that a first channel groove of the two channel grooves is fluidically connected to the first opening and the first channel and a second channel groove of the two channel grooves is fluidically connected to the second opening and the second channel. Thus, refrigerant can flow through the openings of the connecting plate and the channels of the multi-channel device into the storage channel of the collector and then out again, wherein in particular leakages in this region are prevented. As a result, a relatively simple and flexible mechanical and/or fluidic arrangement of the heat exchanger on the collector can be realised by means of the connecting plate and the multi-channel device.

Practically, the connecting plate can be fixed to the collector, in particular to the connecting flange of the collector, by soldering or screwing. Thus, a leakage of refrigerant between the connecting plate and the connecting flange during the operation of the heat exchanger module can be prevented. In particular it can be provided that the storage channel and the said openings are completely sealed off towards the outside through the solder used during the soldering of connecting plate and connecting flange. In the case of a screw connection of the connecting plate to the connecting flange, for example by way of fastening screws, a said sealing means can be arranged between the connecting flange and the connecting plate for the purpose of sealing the storage channel and the said openings towards the outside. The sealing means can be for example realised by sealing cords, rubber or metal seals or adhesive or the like.

Further practically it can be provided that the channels of the said multi-channel device are realised through separate connecting tubes. Practically, the connecting tubes each have a tube shell and at axial tube ends connecting pieces by way of which a respective connecting tube can be fixed to the one hand to the heat exchanger and on the other hand to the connecting plate. By way of the connecting tubes, the collector and the heat exchanger can be mechanically fixed and/or fluidically connected. For fixing the connecting tubes, solder or fastening screws can be utilised for example in the manner that a connecting piece of a connecting tube is soldered tightly or screwed tightly to the collector and the other connecting piece of the connecting tube to the heat exchanger. Thus, a conceivable embodiment for the multi-channel device is stated. According to an alternative embodiment for the multi-channel device it can be provided that the multi-channel device has a cuboid main body and the said channels of the multi-channel device are realised by bores, which completely penetrate the main body. The bores can be produced for example by mechanically machining the main body, wherein they practically open out on main body surfaces of the main body. Practically, the main body has on these main body surfaces fastening means, by means of which it is fixed to the one hand to the heat exchanger and on the other hand to the connecting plate. Practically, the fastening means are formed by solder or fastening screws. In other words, the main body of the multi-channel device can be fixed to the heat exchanger and the connecting plate by soldering or screwing.

Further it can be provided that the heat exchanger is arranged on the connecting plate and the multi-channel device in a contacting manner. This means that the heat exchanger is in direct contact with the connecting plate and with the multi-channel device, as a result of which for example a relatively compact heat exchanger module can be realised. Depending on specified installation space dimensions it can also be provided, however, that the heat exchanger is arranged on the multi-channel device in a contacting manner, i.e. is in direct contact with the multi-channel device, while with respect to the connecting plate it is contact-free and merely in contact with the connecting plate by way of or subject to the interposing of the multi-channel device. Thus, the heat exchanger module can also be adapted to particularly complex installation space situations.

Further practically it is provided that the connecting plate, in the assembled state of the heat exchanger module, has a large mounting surface facing away with respect to the collector. The large mounting surface is zoned, i.e. divided into a first mounting place equipped for mounting the heat exchanger and into a second mounting place directly adjoining the first mounting place for mounting the multi-channel device. Furthermore it is provided that the heat exchanger is arranged on the first mounting place and fixed to the connecting plate, that the multi-channel device is arranged on the second mounting place and fixed to the connecting plate, and that the said openings are arranged or placed on the second mounting place. Further practically it can be provided that the collector in its main extension direction defines a longitudinal centre axis, by way of which a total height of the connecting plate extending parallel to the longitudinal centre axis, a mounting place height of the first mounting place likewise extending parallel to the longitudinal centre axis and a residual height of the second mounting place likewise extending parallel to the longitudinal centre axis are defined. In order to optimally arrange or position the multi-channel device arranged on the second mounting place with respect to the heat exchanger and the collector, so that a mechanical and fluidic connection between collector and heat exchanger can be relatively easily established, it is provided that the mounting place height is selected depending on a size of the heat exchanger and/or corresponds to a height of the heat exchanger or a total height of the heat exchanger. The said residual height is defined by the total height minus the mounting place height. Furthermore, this has the advantage that the positions of the openings of the connecting plate are optimally selected with respect to a preferred coolant output position on the collector with a view to the specified size and/or height or total height of the heat exchanger.

According to a further basic idea of the invention, a method for providing or realising a heat exchanger module is provided. Initially, it includes the provision of a heat exchanger module according to the preceding description. It is substantial for the method that a position of the first opening of the at least two openings on the connecting plate is defined depending on a size of the heat exchanger, in particular a height of the heat exchanger, and a position of the second opening on the connecting plate depending on a size of the heat exchanger, in particular a height of the heat exchanger. Thus, the two openings or their positions on the connecting plate are flexibly matched to a specified size of the heat exchanger or to a specified installation space dimension. Specifying the position of the two openings has the advantage that the openings are always positioned optimally with respect to the collector and the heat exchanger, so that a simple mechanical and fluidic connection can be established.

According to a further basic idea of the invention, a motor vehicle system is proposed, in particular an air-conditioning system or a heat pump system, which is equipped with at least one heat exchanger module according to the preceding description.

Summarising it should be noted: the present invention practically relates to a heat exchanger module for an air-conditioning system or a heat pump system, which comprises a heat exchanger for cooling refrigerant which is penetrated by a refrigerant channel for refrigerant, and a collector for drying and storing refrigerant, which is penetrated by a storage channel for refrigerant. It is substantial that a heat exchanger module, furthermore, comprises a coupling device equipped for the mechanical and/or fluidic connection of heat exchanger and collector, by way of which in the assembled state of the heat exchanger module, the heat exchanger is mechanically fixed to the collector and/or or the refrigerant channel fluidically connected to the storage channel. Further, the invention practically relates to a method for providing such a heat exchanger module and to a motor vehicle system having at least one such heat exchanger module.

Further important features and advantages of the invention are obtained from the subclaims, from the drawings and from the associated figure description by way of the drawings.

It is to be understood that the features mentioned above and still to be explained in the following cannot only be used in the respective combination stated, but also in other combinations or by themselves without leaving the scope of the present invention.

Preferred exemplary embodiments of the invention are shown in the drawings and are explained in more detail in the following description, wherein same reference numbers relate to same or similar or functionally same components.

It Shows, in Each Case Schematically

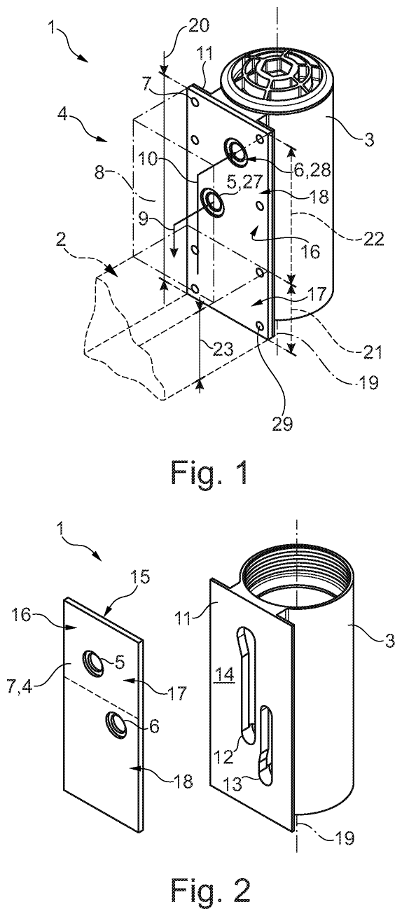

FIG. 1 a perspective view of a heat exchanger module according to a first embodiment,

FIG. 2 a perspective view of a heat exchanger module according to a further embodiment, wherein a cover of the collector and a heat exchanger are not shown and a connecting plate of the coupling device is lifted off the collector,

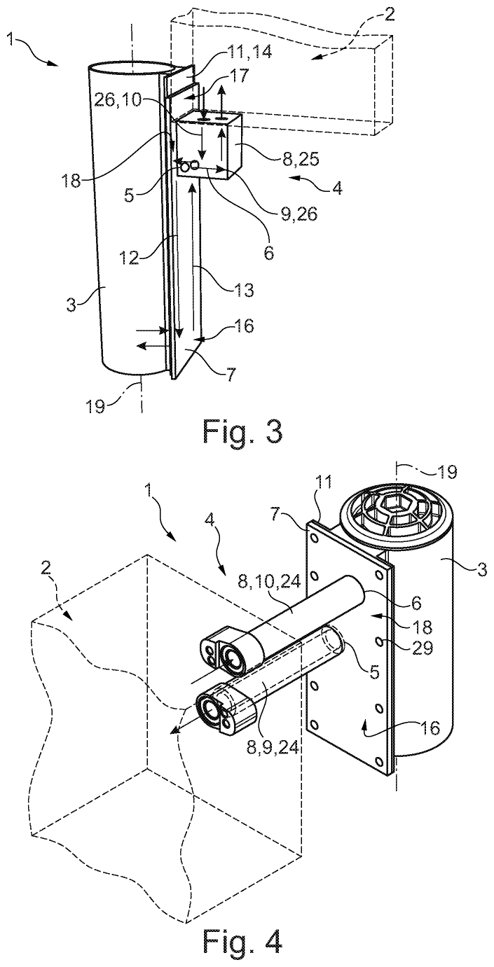

FIGS. 3 and 4 each a perspective view of a heat exchanger module according to a further embodiment.

FIGS. 1 to 4 show a heat exchanger module denoted in the entirety with the reference number 1 in different embodiments, which can be employed in a motor vehicle system that is not illustrated, such as for example an air-conditioning system or a heat pump system of a vehicle.

The heat exchanger module 1 according to FIG. 1 comprises a heat exchanger 2 indicated by a dashed-line box, a collector 3 and a coupling device 4 for the mechanical and fluidic connection of heat exchanger 2 and collector 3. The heat exchanger 2 serves for cooling a refrigerant circulating through the heat exchanger module 1, which is penetrated by a refrigerant channel for refrigerant which is not illustrated here. The heat exchanger 2 can be realised for example by an evaporator or a condenser, in particular by a stacked plate condenser. The said collector 3, which in its main extension direction defines a longitudinal centre axis 19 symbolized in FIGS. 1 to 4 by a dash-dotted line, is penetrated by a storage channel for refrigerant which is not illustrated here in FIGS. 1 to 4 and serves for drying and storing the same. Furthermore, the collector 3 has a rectangular connecting flange 11, which is tangentially arranged on a round-cylindrical collector housing of the collector and comprises a flat mounting surface 14 facing away from the collector housing of the collector 3. On the mounting surface 14, which is equipped for mounting a connecting plate 7 of the said coupling device 4 still to be discussed further, a pair of channel grooves 12, 13, which with respect to one another and with respect to the longitudinal centre axis 19 substantially run parallel, open out for conducting refrigerant, which are fluidically connected to the storage channel of the collector 3, so that refrigerant can for example flow through a first channel groove 12 of these two channel grooves 12, 13 into the storage channel of the collector 3 and then, for example in a dried state, flow through a second channel groove 13 of these two channel grooves 12, 13 again out of the storage channel of the collector 3. The said coupling device 4 comprises a connecting plate 7 comprising two openings 5, 6 for refrigerant and a multi-channel device 8 arranged on the same. Here, the latter is symbolized in FIG. 1 by a simple cuboid drawn with dash-dotted line and has a first channel 9 fluidically connected to a first opening 5 of the two openings 5, 6 of the connecting plate 7 and a second channel 10 fluidically connected to a second opening 6 of the two openings 5, 6 of the connecting plate 7. Purely exemplarily, the two channels 9, 10 of the multi-channel device 8 in FIG. 1 are indicated by simple arrows, so that it is noticeable that during the operation of the heat exchanger module 1 refrigerant can flow for example through the one channel 10 of the multi-channel device 8 via the opening 6 into the storage channel of the collector 3 and can then flow via the other opening 5 via the other channel 9 again out of the storage channel of the collector 3, or vice versa. In the assembled state of the heat exchanger module 1 illustrated in FIG. 1, the heat exchanger 2 is both mechanically fixed to the collector 3 by way of the coupling device 4 and the said refrigerant channel is also fluidically connected to the said storage channel, so that the said refrigerant circuit can be realised, in which refrigerant can flow from the refrigerant channel of the heat exchanger 2 to the storage channel of the collector 3 and then from the storage channel of the collector 3 back again to the refrigerant channel of the heat exchanger 2.

In FIG. 1 it is evident, furthermore, that the connecting plate 7, with a large plate surface located opposite with respect to the multi-channel device 8, is directly arranged on the mounting surface 14 of the connecting flange 11 in a contacting manner and fixed to the connecting flange 11, as a result of which the first channel groove 12 of the two channel grooves 12, 13 is fluidically connected to the first opening 5 and the first channel 9 and the channel groove 13 of the two channel grooves 12, 13 is fluidically connected to the second opening 6 and the second channel 10. Purely exemplarily it can be provided that the connecting plate 7 is fixed to the connecting flange 11 of the collector 3 by soldering. However, a screw connection by way of fastening screws 29 is provided here.

Furthermore, it must be explained viewing FIGS. 1 to 3 that the connecting plate 7 comprises a large mounting surface 16 which in the assembled state of the heat exchanger module 1 faces away with respect to the collector 3. The large mounting surface 16 can be zoned into a first mounting place 17 equipped for mounting the heat exchanger 2 and into a second mounting place 18 equipped for mounting the multi-channel device 8 adjoining the first mounting place 17. Furthermore, the heat exchanger 2 is thus arranged on the first mounting place 17 and fixed to the connecting plate, while the multi-channel device 8 is arranged on the second mounting place 18 and in turn fixed to the connecting plate 7. Furthermore, the said openings 5, 6 are arranged on the first and/or second mounting place 17, 18. Further, the connecting plate 7 has a total height 20 extending parallel to the longitudinal centre axis 19, the first mounting place 17 a mounting place height 21 likewise extending parallel to the longitudinal centre axis 19 and the second mounting place 18 a residual height 22 likewise extending parallel to the longitudinal centre axis 19. In order to optimally arrange or position the multi-channel device 8 and the two openings 5, 6 with respect to the heat exchanger 2 and the collector 3 on the connecting plate 7, so that a mechanical and fluidic connection between collector 3 and heat exchanger 2 can be established relatively easily and in a space-saving manner, it is practically provided that the mounting place height 21 is selected depending on a size of the heat exchanger 2, in particular a size 23 of the heat exchanger 2, and simultaneously a position 27 of the first opening 5 on the connecting plate 7 and a position 28 of the second opening 6 on the connecting plate 7 is selected depending on the size of the heat exchanger 2, in particular the height 23 of the heat exchanger 2. The said residual height 22 is then obtained by the total height 20 minus the mounting place height 21.

Viewing FIG. 3 it should be noted, furthermore, that according to the embodiment of the heat exchanger module 1 there, the coupling device 4 comprises a modified connecting plate 7 and has a preferred multi-channel device 8 with cuboid main body 25. With respect to the connecting plate 7 it should be noted that the mounting place height 21 of the first mounting place 17 selected here is relatively small compared with the mounting place height 21 of the first mounting place 17 selected in the embodiment according to FIGS. 1 and 2, so that the residual height 22 according to the embodiment of the heat exchanger module 1 shown in FIG. 3 is relatively large. The channels 9, 10 of the multi-channel device 8 are realised by bores which penetrate the said main body 25.

In FIG. 4, a further embodiment of the heat exchanger module 1 is shown, in which the channels 9, 10 of the multi-channel device 8 are realised by two separate connecting tubes 24. The connecting tubes 24 exemplarily have at their axial tube ends connecting pieces by way of which a respective connecting tube 24 can be fixed to the one hand to the heat exchanger 2 and on the other hand to the connecting plate 7. Here, the heat exchanger 2 is not directly connected to the collector 3 and/or the connecting plate 7, but merely indirectly by way of the connecting tubes 24.

The specification can be best understood with reference to the following Numbered Paragraphs:

Numbered Paragraph 1. A heat exchanger module (1) for an air-conditioning system or a heat pump system,
having a heat exchanger (2) for cooling refrigerant, which is penetrated by a refrigerant channel for refrigerant,
having a collector (3) for drying and storing refrigerant, which is penetrated by a storage channel for refrigerant,
having a coupling device (4) equipped for the mechanical and/or fluidic connection of heat exchanger (2) and collector (3), by way of which in an assembled state of the heat exchanger module (1) the heat exchanger (2) is mechanically fixed to the collector (3) and/or the refrigerant channel fluidically connected to the storage channel.

Numbered Paragraph 2. The heat exchanger module (1) according to Numbered Paragraph 1,

characterised in that
the coupling device (4) is in multiple parts.

Numbered Paragraph 3. The heat exchanger module (1) according to either one of Numbered Paragraphs 1 or 2,

characterised in that
the coupling device (4) is arranged sandwich-like between heat exchanger (2) and collector (3).

Numbered Paragraph 4. The heat exchanger module (1) according to any one of the preceding Numbered Paragraphs,

characterised in that
the coupling device (4) has a connecting plate 7 comprising at least two openings (5, 6) and a multi-channel device (8) arranged on the same, which comprises a first channel (9) fluidically connected to a first opening (5) of the at least two openings (5, 6) and a second channel (10) fluidically connected to a second opening (6) of the at least two openings (5, 6).

Numbered Paragraph 5. The heat exchanger module (1) according to Numbered Paragraph 4,

characterised in that
the collector (3) comprises a connecting flange (11), which comprises a mounting surface (14) equipped for mounting the connecting plate (7) and a pair of channel grooves (12, 13) for conducting refrigerant, which open out on the mounting surface (14) and are fluidically connected to the storage channel,
wherein the connecting plate (7), with a large plate surface (15) located opposite with respect to the multi-channel device (8), is directly arranged on the mounting surface (14) in a contacting manner or subject to interposing a sealing means, and fixed to the connecting flange (11), so that a first channel groove (12) of the two channel grooves (12, 13) is fluidically connected to the first opening (5) and the first channel (9) and a second channel groove (13) of the two channel grooves (12, 13) is fluidically connected to the second opening (6) and the second channel (10).

Numbered Paragraph 6. The heat exchanger module (1) according to any one of the Numbered Paragraphs 4 or 5,

characterised in that
the connecting plate (7) is fixed to the collector (3) by soldering or screwing, in particular on the connecting flange (11) of the collector (3).

Numbered Paragraph 7. The heat exchanger module (1) according to the Numbered Paragraphs 4 to 6,

characterised in that
the channels (9, 10) of the multi-channel device (8) are realised by connecting tubes (24).

Numbered Paragraph 8. The heat exchanger module (1) according to the Numbered Paragraphs 4 to 6,

characterised in that
the multi-channel device (8) has a cuboid main body (25),
the channels (9, 10) of the multi-channel device (8) are realised by bores (26) which penetrate the main body (25).

Numbered Paragraph 9. The heat exchanger module (1) according to any one of the Numbered Paragraphs 4 to 8,

characterised in that
the heat exchanger (2) is arranged on the connecting plate (7) and the multi-channel device (8) in a contacting manner, or
the heat exchanger (2) is arranged on the multi-channel device (8) in a contacting manner and is contact-free with respect to the connecting plate (7).

Numbered Paragraph 10. The heat exchanger module (1) according to any one of the Numbered Paragraphs 4 to 9,

characterised in that
the connecting plate (7) has a large mounting surface (16) which in the assembled state of the heat exchanger module (1) faces away with respect to the collector (3), which is zoned in a first mounting place (17) equipped for mounting the heat exchanger (2) and into a second mounting place (18) equipped for mounting the multi-channel device (8),
wherein the heat exchanger (2) is touchingly arranged on the first mounting place (17) and fixed to the connecting plate (7),
wherein the multi-channel device (8) is arranged on the second mounting place (18) and fixed to the connecting plate (7),
wherein the first opening (5) and the second opening (6) are arranged on the second mounting place (18).

Numbered Paragraph 11. The heat exchanger module (1) according to Numbered Paragraph 10,

characterised in that
the collector (3) in its main extension direction defines a longitudinal centre axis (19),
the connecting plate (7) has a total height (20) extending parallel to the longitudinal centre axis (19),
the first mounting place (17) has a mounting place height (21) extending parallel to the longitudinal centre axis (19),
the second mounting place (18) has a residual height (22) extending parallel to the longitudinal centre axis (19),
wherein the mounting place height (21), depending on a size of the heat exchanger (2), in particular corresponds to a height (23) of the heat exchanger (2),
wherein the residual height (22) is defined by the total height (20) minus the mounting place height (21).

Numbered Paragraph 12. A method for providing a heat exchanger module (1),
providing a heat exchanger module (1) according to the preceding Numbered Paragraphs,
wherein a position (27) of the first opening (5) on the connecting plate (7) is selected depending on a size of the heat exchanger (2), in particular a height (23) of the heat exchanger (2),
wherein a position (28) of the second opening (6) on the connecting plate (7) is selected depending on a size of the heat exchanger (2), in particular a height (23) of the heat exchanger (2).

Numbered Paragraph 13. A motor vehicle system, in particular an air-conditioning system or a heat pump system, having at least one heat exchanger module (1) according to any one of the preceding Numbered Paragraphs.

1. A heat exchanger module for an air-conditioning system or a heat pump system, comprising:
a heat exchanger for cooling refrigerant, which is penetrated by a refrigerant channel for refrigerant,
a collector for drying and storing refrigerant, which is penetrated by a storage channel for refrigerant,
a coupling device equipped for the mechanical and/or fluidic connection of heat exchanger and collector, by way of which in an assembled state of the heat exchanger module the heat exchanger is mechanically fixed to the collector and/or the refrigerant channel fluidically connected to the storage channel.

2. The heat exchanger module according to claim 1, wherein the coupling device is in multiple parts.

3. The heat exchanger module according to claim 1, wherein the coupling device is arranged sandwich-like between heat exchanger and collector.

4. The heat exchanger module according to claim 1, wherein the coupling device has a connecting plate 7 comprising at least two openings and a multi-channel device arranged on the same, which comprises a first channel fluidically connected to a first opening of the at least two and a second channel fluidically connected to a second opening of the at least two openings.

5. The heat exchanger module according to claim 4, wherein
the collector comprises a connecting flange, which comprises a mounting surface equipped for mounting the connecting plate and a pair of channel grooves for conducting refrigerant, which open out on the mounting surface and are fluidically connected to the storage channel,
wherein the connecting plate, with a large plate surface located opposite with respect to the multi-channel device, is directly arranged on the mounting surface in a contacting manner or subject to interposing a sealing means, and fixed to the connecting flange, so that a first channel groove of the two channel grooves is fluidically connected to the first opening and the first channel and a second channel groove of the two channel grooves is fluidically connected to the second opening and the second channel.

6. The heat exchanger module (1) according to claim 4, wherein the connecting plate is fixed to the collector by soldering or screwing, in particular on the connecting flange of the collector.

7. The heat exchanger module according to claim 4, wherein the channels of the multi-channel device are realised by connecting tubes.

8. The heat exchanger module according to claim 4, wherein
the multi-channel device has a cuboid main body,
the channels of the multi-channel device are realised by bores which penetrate the main body.

9. The heat exchanger module (1) according to claim 4, wherein
the heat exchanger is arranged on the connecting plate and the multi-channel device in a contacting manner, or
the heat exchanger is arranged on the multi-channel device (8) in a contacting manner and is contact-free with respect to the connecting plate (7).

10. The heat exchanger module according to claim 4, wherein
the connecting plate has a large mounting surface which in the assembled state of the heat exchanger module faces away with respect to the collector, which is zoned in a first mounting place equipped for mounting the heat exchanger and into a second mounting place equipped for mounting the multi-channel device,
wherein the heat exchanger is touchingly arranged on the first mounting place and fixed to the connecting plate,
wherein the multi-channel device is arranged on the second mounting place and fixed to the connecting plate, and
wherein the first opening and the second opening are arranged on the second mounting place.

11. The heat exchanger module according to claim 10, wherein
the collector in its main extension direction defines a longitudinal centre axis,
the connecting plate has a total height extending parallel to the longitudinal centre axis,
the first mounting place has a mounting place height extending parallel to the longitudinal centre axis,
the second mounting place has a residual height extending parallel to the longitudinal centre axis,
wherein the mounting place height, depending on a size of the heat exchanger, in particular corresponds to a height of the heat exchanger, and
wherein the residual height is defined by the total height minus the mounting place height.

12. A method for providing a heat exchanger module,
providing a heat exchanger module according to claim 1,
wherein a position of the first opening on the connecting plate is selected depending on a size of the heat exchanger, in particular a height of the heat exchanger,
wherein a position of the second opening on the connecting plate is selected depending on a size of the heat exchanger, in particular a height of the heat exchanger.

13. A motor vehicle system, in particular an air-conditioning system or a heat pump system, having at least one heat exchanger module according to claim 1.
